(19) United States
(12) Patent Application Publication
(10) Pub. No.: US 2025/0042084 A1
(43) Pub. Date: Feb. 6, 2025

(54) POWDER-BED BASED ADDITIVE MANUFACTURING METHOD

(71) Applicants: SAFRAN ADDITIVE MANUFACTURING CAMPUS, Le Haillan (FR); SAFRAN, Paris (FR)

(72) Inventors: Romain Bergeron, Moissy-Cramayel (FR); Loïc Ferrage, Moissy-Cramayel (FR); Karine Nguyen, Moissy-Cramayel (FR)

(73) Assignees: SAFRAN ADDITIVE MANUFACTURING CAMPUS, Le Haillan (FR); SAFRAN, Paris (FR)

(21) Appl. No.: 18/719,949

(22) PCT Filed: Dec. 12, 2022
(86) PCT No.: PCT/FR2022/052312

§ 371 Date: Jun. 14, 2024

(30) Foreign Application Priority Data
Dec. 16, 2021 (FR) 2113696

(51) Int. Cl. B29C 64/153; B29C 64/336; B29C 64/371; B33Y 10/00; B33Y 30/00; B33Y 40/00; B33Y 70/10

(52) U.S. Cl. CPC B29C 64/153; B29C 64/336; B29C 64/371; B33Y 10/00; B33Y 30/00; B33Y 40/00; B33Y 70/10

(57) ABSTRACT

A process for additive manufacturing of a part by successive deposition of layers of powder layers is provided. The process steps are performed within a manufacturing machine having a preparation zone for at least one layer and a consolidation zone for the powder, offset from each other. The process includes: (a) preparing at least one layer comprising at least two zones filled with at least two different powders, e.g., of different materials and/or particle sizes, in the preparation zone; (b) moving the at least one layer into the consolidation zone; (c) placing the at least one layer on either a manufacturing support or on an already consolidated portion of the part; and (d) consolidating at least one portion of the at least one layer by sintering, by melting, or by adding a binder.

### FIELD OF THE INVENTION

The present disclosure arises from the field of additive fabrication on powder bed such as selective melting by laser or “Laser Beam Melting” (LBM), by an electron beam or “Electron Beam Melting” (EBM) or by binder jet, also called “Binder Jetting.”

### DESCRIPTION OF RELATED ART

The present document is in the context of an improvement of the process of additive fabrication on powder bed. Among these processes is a process of selective melting by laser or “Laser Beam Melting” (LBM), a process in which a laser beam is replaced by an electron beam or “Electron-Beam Melting” (EBM), or even a process operating by local application of binder configured for forming a part called “green” which is then sintered by thermal treatment.

FIG. 1 shows a selective powder melting installation used for manufacturing parts such as for example turbomachine vanes. This installation comprises a tank 1 containing a metal powder 2 and whose bottom 3 is mobile and movable in vertical translation by a rod 4 of a cylinder, and the neighboring vat 5 whose bottom is made up of a mobile plate 6 also movable in vertical translation by a rod 7 of a cylinder.

The installation further comprises a scraper 8 serving to bring the powder from the tank 1 to the vat 5 by movement in a horizontal plane A, and means for generation 9 of a laser beam, coupled to a computer-controlled device 10 in order to direct and move the beam 11. A receiving bin 12 for the excess powder 13 may also be provided adjacent to the vat 5. This receiving bin 12 for the excess powder 13 may be replaced by an internal, automated recycling system.

The following is the operation of this installation.

First, the bottom 3 of the tank 1 is moved upward so that some quantity of powder 2 is located above the horizontal plane A. The scraper 8 is moved from left to right, so as to scrape said powder layer 2 into the reservoir 1 and lay a thin metal powder layer on the flat horizontal surface of the tray 6.

The quantity of powder 2 and the position of the tray 6 are determined in order to form a powder layer with a selected and constant thickness.

A laser beam 11, perpendicular to the plane A, sweeps a set area of the powder layer formed in the vat 5 so as to locally melt it, where the assembly is contained in an enclosure filled with inert gas. The melted areas then solidify forming a first layer of material 14, where this layer has for example a thickness of order 10 to 150 μm.

These steps are then repeated to successively form the various layers of the part.

The aforementioned processes thus consist of spreading fine layers of powder and consolidating portions of the layers on each other in order to form three-dimensional parts. The scraper may be stiff or comprise a flexible portion, for example of silicone, intended to be in contact with the powder. As a variant, the scraper may be formed by a brush.

In these processes from the prior art, each layer is made up of a single type of powder, spread homogeneously. These processes do not provide for being able to use different kinds of powders. Different kind or different type is understood to mean both different chemical composition and also different particle-size distribution.

Today there is a need to be able to make parts comprising zones of different kinds or having different chemical and/or mechanical and/or electrical and/or microstructure properties. Further, maintaining the inerting of the enclosure is relatively complicated. The inerting of a large volume chamber is costly and slow. Finally, residual stresses which could be present in the previously consolidated material may generate deformations of the powder bed. These deformations may generate catches for the scraper during movement thereof, or even interruptions of scraping.

### BRIEF SUMMARY OF THE INVENTION

The present disclosure aims to improve the situation.

The present document relates to a process for additive manufacturing of a part by successive deposition of powder layers, within a manufacturing machine comprising a preparation zone for at least one layer and a consolidation zone for the powder, offset from each other, where said process comprises the following steps:
a) preparing at least one layer comprising at least two zones filled with at least two different powders, for example of different materials and/or particle sizes, in said preparation zone;
b) moving the layer thus prepared into the consolidation zone;
c) placing said prepared layer on a manufacturing support or on an already consolidated portion of said part;
d) consolidating at least one portion of said layer, for example by sintering or melting, or by adding a binder.

With this process, a part can be made simply and reliably from at least two powders of different kinds.

The use of a preparation zone and a distinct consolidation zone serve to reduce the manufacturing time of the parts. In fact, the tasks done in these zones are executed in parallel, multitasking.

This process can also limit problems of bulk and therefore of inerting the consolidation zone. Further, it is not necessary to use a complex system comprising a scraper which may catch on possible defects in the layers that are already formed.

The steps (a) to (d) may be repeated successively so as to form several layers of the part, superimposed on each other.

It is thus possible to progressively form the part layer by layer, by repeating the aforementioned steps.

An inert gas may be added to the consolidation zone, at least during step d).

The inert gas may be argon or nitrogen.

During step (a), different powder types may be deposited in distinct cells of a tray, where said layer is prepared in said tray, and said tray is moved into the consolidation zone during step (b).

The cells may be fillable separately from each other, for example via at least one nozzle and/or at least one hopper.

The cells may be arranged in rows and columns.

The tray may be equipped with a bottom that is at least in part movable, where said bottom blocks the cells during steps (a) and (b), where said bottom is moved so as to free the cells during step c) and to allow the release by gravity of the powder contained in said freed cells.

The bottom may be moved by translation for example along a horizontal axis, or by rotation around an axis, for example a vertical axis.

During step a), at least one first zone may be filled with a first powder using a first nozzle, and at least one second zone may be filled with a second powder using a second nozzle.

Of course, it is possible to use more than two nozzles, intended to deposit more than two different powder types.

In step a), at least one first zone may be filled with a first powder using a first hopper, and at least one second zone may be filled with a second powder using a second hopper.

Each hopper may comprise several zones openable and closable independently of each other.

Each hopper may for example comprise closures able to selectively free the powder from one zone and/or another zone for the hopper.

The hopper may be moved facing a tray comprising cells distinct from each other, where each zone extends facing one cell or group of cells of the tray so as to be able to selectively feed each cell or each group of cells with powder.

The consolidation of at least one layer (step d) may be done at least partially simultaneously with the preparation (step a) of a subsequent layer or upper layer.

The present document also relates to a manufacturing machine comprising a preparation zone for at least one layer and a consolidation zone for the powder, offset from each other, at least one tray comprising at least two zones intended to be filled with different powders, means for moving able to move said tray between the preparation zone and the consolidation zone, and means of opening said zones intended to be filled with powder able to free the powder contained in said zones by gravity.

The means for opening may be formed by a mobile bottom, for example a bottom movable in translation. Of course, other means of opening may be used.

The tray may comprise a grid comprising cells distinct from each other.

### BRIEF DESCRIPTION OF THE DRAWINGS

Other characteristics details and advantages will appear upon reading the following detailed description, and analyzing the attached drawings, on which:

FIG. 1 shows an additive manufacturing machine from the prior art.

FIG. 2 shows an additive manufacturing machine comprising nozzles, according to the present document.

FIG. 3 is a detailed view from FIG. 2, showing a step in which the tray was moved into the preparation zone.

FIG. 4 is a view corresponding to FIG. 3, showing a step in which the tray is moved into the consolidation zone.

FIG. 5 is a view corresponding to FIG. 3, showing a step in which the bottom is moved in translation relative to the grid of the tray, towards the preparation zone.

FIG. 6 is a view corresponding to FIG. 3, showing a step in which the grid is also moved towards the preparation zone.

FIG. 7 shows an additive manufacturing machine comprising hoppers, according to the present document.

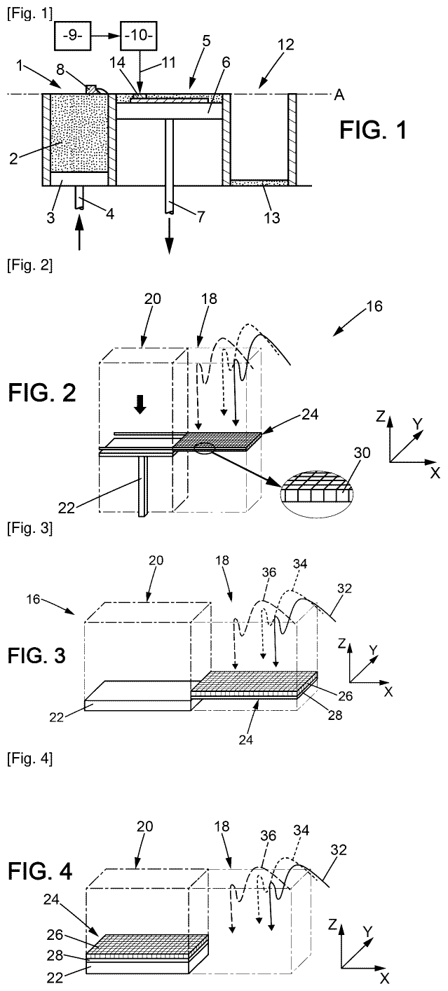

### DETAILED DESCRIPTION OF THE INVENTION

FIG. 2 shows an additive manufacturing machine 16 comprising a preparation zone 18 and a consolidation zone 20 offset from each other along an axis X.

The preparation zone comprises a manufacturing support 22 movable in translation along an axis Z perpendicular to the axis X. Said consolidation zone 20 further comprises consolidation means (not shown), able to consolidate the powder by sintering, melting or by addition of a binder for example. Such consolidation means comprise for example means for generation of a laser or an electron beam movable over the surface of the powdered layer to be consolidated. As a variant, such consolidation means may comprise means for bringing a binder in liquid form for example and possibly means for heating said binder, which could also be movable over the surface of the powder layer to be consolidated.

The machine further comprises a tray 24 comprising a grid 26 and a bottom 28. The grid 26 comprises uniformly distributed cells 30, arranged for example in rows and columns along a plane XY.

The grid 26 and the bottom 28 may be moved in translation along the axis X, independently of each other, for example using rails.

The cells 30 of the grid 26 comprise open lower and upper ends, since the bottom 28 is able to block the lower ends of the cells when the bottom is placed under the grid 26, as shown in FIG. 3.

The machine further comprises at least two nozzles, for example three nozzles 32, 34, 36, each movable in the plane XY at least and able to fill all or part of the cells 30 of the grid 26 of the tray 24. Each nozzle 32, 34, 36 is in particular able to deliver the powder of a set kind. Thus, a first nozzle 32 is for example able to fill some cells 30 of the grid 26 with a first type of powder, a second nozzle 34 is for example able to fill other cells 30 of the grid 26 with a second type of powder and the third nozzle 36 is able for example to fill other cells 30 of the grid 20 with a third type of powder.

Further, the consolidation zone 20 may be housed in an enclosure filled with inert gas, such as for example argon or nitrogen. Conversely, the preparation zone 18 may not have such inerting means.

As can be seen in FIG. 3, the tray 24 may be located entirely in the preparation zone 18 and the cells 30 may be filled, at least in part, with powders of different kinds, using nozzles 32, 34, 36.

The tray may then be moved entirely into the consolidation zone 20, containing the inert gas, as shown in FIG. 4.

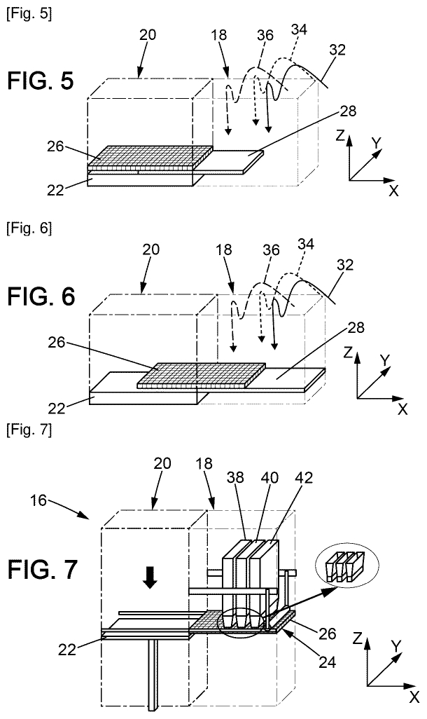

The bottom 28 of the tray 24 can then be moved towards the preparation zone 18, as shown in FIG. 5, such that the powder contained in the cells 30 is directed by gravity onto the manufacturing support 22.

The grid 26 of the tray 24 may then also be moved towards the preparation zone 18, as shown in FIG. 6.

Once the consolidation zone 20 is freed of the tray 24, some zones of the powder layer thus deposited may be selectively consolidated, so as to form a layer of the part to be made.

The manufacturing support 22 may then be moved downwards in translation along the axis Z, and it is then possible to repeat the preceding steps so as to build the part layer by layer.

FIG. 7 shows an additive manufacturing machine 16 according to another embodiment, which differs from that previously described in that the nozzles 32, 34, 36 are replaced by hoppers, for example three hoppers 38, 40, 42. The hoppers 38, 40, 42 are intended to supply the tray 24 with powders of various kinds. Each hopper extends for example along the axis Y and comprises several openings or zones distributed on the axis Y openable or closable independently of each other. The number of zones is equal for example to the number of cells 30 of the grid 26 along the axis Y, meaning to the number of cells 30 of a row or column of the grid 26. Each hopper 38, 40, 42 can further be placed before each row of the grid 26. In this way each cell 30 of the grid 26 may be filled by the powder contained in one of the hoppers 38, 40, 42.

As before, once the tray 24 is filled with powder, the tray is brought into the consolidation zone 20 before depositing the corresponding powder layer onto the manufacturing support 22 or onto the already consolidated layer. This powder layer is then consolidated in whole or part, as before, so as to form a layer of the part.

As a variant, the cells may comprise means for selective opening or closing of their upper ends.

The invention claimed is:

1. A process for additive manufacturing of a part by successive deposition of powder layers within a manufacturing machine having a preparation zone of at least one layer and a consolidation zone of the powder, the preparation zone and the consolidation zone being offset from each other, the process comprising the following steps:
preparing at least one layer comprising at least two zones filled with at least two different powders in the preparation zone;
moving the at least one layer from the preparation zone into the consolidation zone;
placing the at least one layer on either a manufacturing support or on an already consolidated portion of the part; and
(d) consolidating at least one portion of the at least one layer by sintering, by melting, or by adding a binder.

2. The process of claim 1, wherein the steps (a) to (d) are repeated successively so as to form several layers of the part superimposed on each other.

3. The process of claim 1, wherein an inert gas is added to the consolidation zone at least during step (d).

4. The process of claim 1, wherein, during step (a), different powder types are deposited in distinct cells of a tray, wherein the at least one layer is prepared in the tray, and wherein the tray having the at least one layer is moved into the consolidation zone during step (b).

5. The process of claim 4, wherein the tray is equipped with a bottom that is at least in part movable, wherein the bottom blocks the cells during steps (a) and (b), and wherein the bottom is moved so as to free the cells during step (c) to allow the release by gravity of the powder contained in the freed cells.

6. The process of claim 1, wherein, during step (a), at least one first zone is filled with a first powder using a first nozzle, and at least one second zone is filled with a second powder using a second nozzle.

7. The process claim 1, wherein, in step (a), at least one first zone is filled with a first powder using a first hopper, and at least one second zone is filled with a second powder using a second hopper.

8. The process of claim 7, wherein each hopper comprises several zones openable and closable independently of each other.

9. A manufacturing machine, comprising:
a preparation zone of at least one layer;
a consolidation zone of the powder, the preparation zone and the consolidation zone being offset from each other;
at least one tray comprising at least two zones configured to be filled with different powders, means for moving the tray between the preparation zone and the consolidation zone; and
means of opening the zones to free the powder contained in the zones by gravity.

10. The machine of claim 9, wherein the tray comprises a grid having a plurality of cells distinct from each other.

11. The process of claim 1, wherein the at least two different powders differ in material and/or particle size from each other.
